(19) United States
(12) Patent Application Publication
(10) Pub. No.: US 2013/0046964 A1
(43) Pub. Date: Feb. 21, 2013

(54) SYSTEM AND METHOD FOR ZERO PENALTY BRANCH MIS-PREDICTIONS

(71) Applicant: Noam DVORETZKI, Hod HaSharon (IL)

(72) Inventor: Noam DVORETZKI, Hod HaSharon (IL)

(21) Appl. No.: 13/209,484

(22) Filed: Aug. 15, 2011

(51) Int. Cl. G06F 9/38

(52) U.S. Cl. 712/235; 712/E09.045

(57) ABSTRACT

A system and method may execute a branch instruction in a program. The branch instruction may be received defining a plurality of different possible instruction paths. Instructions for an initial predefined one of the paths may be automatically retrieved from a program memory while the correct path is being determined. If the initial path is determined to be correct, the instructions retrieved for the initial path may continue to be processed and if a different path is determined to be correct, instructions from a stored reserve of instructions may be processed for the different path to supply the program with enough correct path instructions to run the program at least until the program retrieves the correct path instructions from the program memory to recover from taking the incorrect path. The system and method may recover from taking the incorrect path with zero computational penalty.

### FIELD OF THE INVENTION

The present invention relates to systems and methods for executing branch instructions.

### BACKGROUND OF THE INVENTION

A program may include a branch instruction at which, based on a branch condition, a process may proceed in one of multiple possible instruction paths. To avoid time delays, instructions are typically retrieved from program memory ahead of time so that they are ready for use when they are needed in the processor pipeline. However, at a branch, the next instruction may be unknown until the branch instruction is executed. Therefore, subsequent instructions can not be fetched beforehand, thereby causing a time delay in the process pipeline.

To reduce such time delays, a branch predictor may be used to predict the outcome of a conditional branch. The predicted instructions at the branch are preemptively retrieved from program memory and temporarily stored in a program buffer or cache for easy access. However, branch predictors may perform poorly for some algorithms, e.g., predicting correctly at approximately 50% of branches and predicting incorrectly at approximately 50% of branches.

When a branch prediction is correct, the predicted instructions are already available for immediate retrieval from the program buffer. When the branch prediction is incorrect, the retrieved instructions are discarded and the processor may again retrieve the correct instructions from program memory using additional computational cycles. The additional computational cycles used to retrieve the correct instructions from program memory after a branch mis-prediction may be referred to as a branch mis-prediction penalty.

There is a need in the art to reduce the computational penalty of branch mis-predictions.

### BRIEF DESCRIPTION OF THE DRAWINGS

Specific embodiments of the present invention will be described with reference to the following drawings, wherein:

FIG. 1 is a schematic illustration of a system in accordance with an embodiment of the invention;

FIG. 2 is a table showing processor operations initiated by a branch instruction in accordance with some embodiments of the invention;

FIG. 3 is a schematic illustration of buffers for storing instructions in accordance with some embodiments of the invention; and

FIG. 4 is a flowchart of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

Some embodiments of the invention provide a system and method for executing a branch instruction in a program. The branch instruction may be received defining a plurality of different possible instruction paths. Instructions for an initial predefined one of the paths, for example, the branch taken path, may be automatically retrieved from a program memory while the correct path is being determined. If the initial path is determined to be correct, the instructions retrieved for the initial path may continue to be processed. However, if a different path is determined to be correct, for example, the branch not taken path, instructions from a stored reserve of instructions may be processed for the different path to supply the program with enough correct path instructions to run the program at least until the program retrieves the correct path instructions from the program memory to recover from taking the incorrect path. Embodiments of the invention may recover from taking the incorrect path with zero computational penalty.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

A sequence of instructions 1, 2, 3, 4, 5, . . . may include a branch instruction, e.g., 5, with two possible paths, for example, to either continue sequentially to instructions 6, 7, 8, . . . (branch not taken) or to jump ahead to instructions 100, 101, 102, . . . (branch taken). The correct path may depend on a branch condition. A true branch condition may indicate that the branch should be taken, while a false branch condition may indicate the branch should not be taken. However, determining the branch condition may take several cycles.

In conventional systems, instead of waiting for the branch condition to be determined, which may cause a processing delay of several cycles, a branch prediction unit may predict the outcome of the branch condition and thus, the branch path. The instructions for the predicted path may be retrieved and queued in a buffer while the condition is being determined. Once the branch condition is determined, it may be determined if the predicted path is correct or incorrect (e.g., a true branch condition=take branch and a false branch condition=don't take branch). If the branch prediction unit predicts a correct path, the retrieved instructions may be used to accurately continue the program. However, if the branch prediction unit is incorrect, the retrieved instructions are discarded and the process may return to the program memory to re-retrieve instructions for the other path, thereby incurring a mis-prediction penalty for the wasted program cycles. When branch conditions are difficult to predict or poorly correlated to past events, mis-prediction penalties may be more frequent and may significantly stall system processes.

Embodiments of the invention may eliminate mis-prediction penalties, which may be especially beneficial for systems with poor branch prediction capabilities. Instead of predicting the correct branch path, embodiments of the invention may always proceed with the branch taken path, regardless of the branch condition. If the branch taken path is correct, all the instruction queue buffers may be flushed and filled with the retrieved branch taken instructions to accurately continue the program. However, if the branch taken path is incorrect, the system may discard the branch taken instructions wasting (N) cycles used to retrieve them (while the branch condition is being processed, but not yet known) and an additional (M) cycles to recover and take the correct path to retrieve the branch not taken instructions. Thus, to fully recover from the incorrect path and proceed in the correct path, a total of (N+M) cycles may be used. To avoid the mis-prediction penalty for taking the incorrect path, embodiments of the invention may buffer a number of instructions in the sequential (not taken) path equal to (or greater than) the number of cycles to fully recover from a mis-prediction (e.g., N≧M cycles). Such a reserve may supply enough instructions to run the program (e.g., at a rate of one instruction packet per cycle) at least until the program is fully recovered from the mis-prediction. In one example, three cycles (e.g., D2-E1) may be used to determine the branch condition and two cycles (e.g., IF1-IF2) may be used to retrieve the correct instructions from the program memory for a total of five delay cycles to recover from the incorrect path. Other numbers of recovery cycles may be used and therefore other numbers of buffered instructions (equal (or greater) thereto) may likewise be used.

By always taking one branch path (e.g., the branch taken path), while buffering a reserve of instructions for the other one or more possible branch paths (e.g., the branch not taken path), embodiments of the invention may guarantee the correct instructions are available regardless of the outcome of the branch condition or which path is correct, thereby providing a zero cycle penalty for branch mis-predictions.

However, each time an incorrect path is taken, the reserve of instructions in the program buffers may be depleted. The buffer may be replenished for each mis-prediction recovery to repeatedly endure multiple mis-predictions with zero mis-predictions penalty. To replenish the buffered reserve, embodiments of the invention may fill the buffers with instructions at a rate faster than the rate at which instructions are emptied from the buffers (e.g., the buffers may be emptied at a constant rate, such as, one instruction packet per clock cycle). If the influx or fill rate of instructions into the buffers exceeds the output or empty rate of those instructions, the buffered instructions may increase over time until the buffered reserve is accumulated. An instruction packet may include one or more instructions.

Embodiments of the invention may ensure the buffers have a faster fill rate than an empty rate by increasing the size of each buffer. Each buffer is typically filled in each fetch cycle. Since the size of instruction packets may vary, the number of instruction packets stored in each buffer may likewise vary in each cycle. However, the buffer may be sized to be larger than the maximum allowable instruction packet size so that, for example, in a worse-case scenario (for a maximum allowable instruction packet size), each buffer may store more than one instruction packet. The maximal allowable size of instruction packets may be defined by the system storage scheme. For example, if five instruction packets are needed for full recovery, two buffers, each storing at least 2.5 instruction packets of maximum size, may be filled using no more than two consecutive clock cycles. Further increasing the size of each buffer may increase the buffer fill rate and decrease the reserve accumulation time. For example, doubling the buffer size (e.g., to accommodate at least five instruction packets) may half the number of clock cycle (e.g., to no more than a single clock cycle) used to store the complete number of (e.g., five) reserve instruction packets. However, there is limit to how large the buffer size should be set, since a larger buffer size occupies more silicon area on a chip and thus, incurs higher manufacturing costs. To increase the speed of recovery without increasing buffer size, some embodiments may use multiple parallel threads, where each thread fills a different buffer in parallel.

It may be appreciated that, although some embodiments of the invention describe first proceeding with the branch taken instruction path and buffering branch not taken instructions, conversely, such embodiments may be adapted to first proceed with the branch not taken instruction path and buffer branch taken instructions. In such embodiments, embodiments of the invention may always proceed with one predetermined path and buffer instructions for the other path. Furthermore, although some embodiments of the invention describe two instruction paths (e.g., branch taken and not taken), such embodiments may be adapted to include any number of (e.g., 2^{N}) paths (e.g., dependent on (N) multiple branch conditions). In such embodiments, reserve instructions may be buffered for all (e.g., 2^{N}−1) paths not taken.

It may be appreciated that, although some embodiments of the invention may indiscriminately proceed with a specific predefined path (e.g., the branch taken path) and thus no longer make a logical determination, guess, or “prediction” as to the path, as it is used herein a “prediction” may refer to any determination including taking a predetermined path. Similarly, a “mis-prediction” may refer to any determination to take an incorrect path, whether or not the path is predefined.

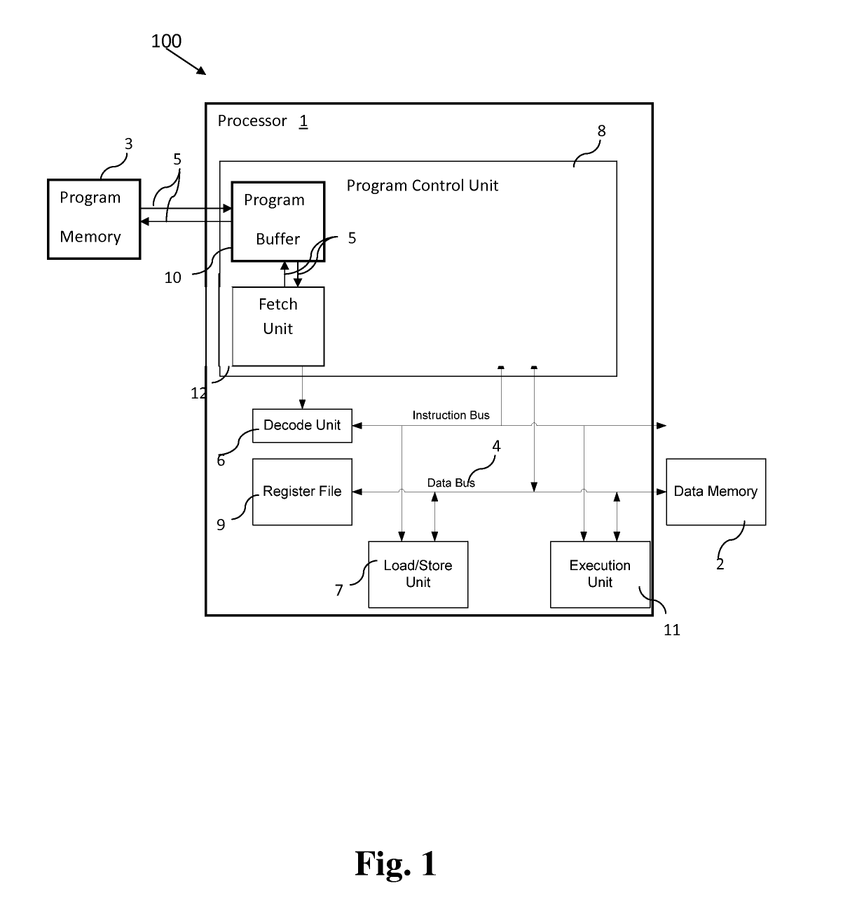

Reference is made to FIG. 1, which is a schematic illustration of a system in accordance with an embodiment of the invention. The system may include a device 100 having a processor 1, a data memory unit 2, a program memory unit 3, a program buffer 10, and a program control unit 8.

Device 100 may include a computer device, cellular device, or any other digital device such as a cellular telephone, personal digital assistant (PDA), video game console, etc. Device 100 may include any device capable of executing a series of instructions to run a computer program.

Processor 1 may include a central processing unit (CPU), a digital signal processor (DSP), a microprocessor, a controller, a chip, a microchip, a field-programmable gate array (FPGA), an application-specific integrated circuit (ASIC) or any other integrated circuit (IC), or any other suitable multi-purpose or specific processor or controller. Processor 1 may be coupled to data memory unit 2 via a data bus 4 and to program memory unit 3 via a program memory bus 5.

Program memory unit 3 typically stores instructions for running a computer program while data memory unit 2 typically stores data generated while operating the program instructions such as pre-generated (e.g., static) data and/or scratch pad (e.g., dynamic) data. Program buffer 10 may provide temporary storage for program instructions retrieved from program memory unit 3 so that the instructions are more accessible for use by program control unit 8. Program memory unit 3 is typically a long term memory unit, while program buffer 10 is typically a short term memory unit. Data memory unit 2, program memory unit 3 and program buffer 10 may include, for example, random access memory (RAM), dynamic RAM (DRAM), flash memory, buffer memory, cache memory, volatile memory, non-volatile memory or other suitable memory units or storage units.

Program control unit 8 may request, retrieve, and dispatch instructions from program memory unit 3 and may be responsible, in general, for the program pipeline flow. A data memory controller (not shown) may be coupled to data memory bus 4, and a program memory controller (not shown) may be coupled to program memory bus 5 to retrieve data from data memory unit 2 and program memory unit 3, respectively. Program control unit 8 may include an instruction fetch unit 12 to retrieve or fetch program instructions from program memory unit 3 and save the instructions to program buffer 10 until they are requested for use by program control unit 8.

Processor 1 may include a decode unit 6, a load/store unit 7, a register file 9, and an execution unit 11. Once instructions are dispatched by program control unit 8, decode unit 6 may decode the instructions. Processor 1 may use register files 9 to implement tags to efficiently access decoded instruction, e.g., in the same computational cycle as they are requested. Execution unit 11 may execute the instructions. Load/store unit 7 may perform load and store operations from/to data memory unit 2.

Processor 1 may execute, for example, the following sequential pipeline stages for each instruction:

IF1—program memory address (operated by program control unit 8)

IF2—program memory fetch (operated by instruction fetch unit 12)

D1—instruction dispatch (operated by program control unit 8)

D2—instruction decode (operated by decode unit 6)

D3—register file read (using register files 9)

E1—execute instruction (operated by execution unit 11).

Other or additional pipeline stages and operating device components may be used.

In a process comprising sequential instructions, instructions to be processed in future are known beforehand and instruction fetch unit 12 may preemptively retrieve instructions so that each instruction is fetched before the processor is ready to dispatch the instruction. The fetched instructions are temporarily stored in program buffer 10, and/or a local queue which is significantly faster to access than program memory 3.

However, instructions succeeding a branch instruction may depend on a branch condition that is not yet known at the time the instructions are to be fetched. For example, the branch instruction may proceed to any of multiple different instructions or process paths depending on the outcome of the branch condition.

Instead of predicting the branch path (which may incur a computational penalty if the predicted path is incorrect), embodiments of the invention may implement a zero-penalty mechanism for processing a branch instruction (even if the predicted or initially taken path is incorrect). According to embodiments of the invention, program control unit 8 may always execute a first instruction path (the branch taken path), while program buffer 10 stores a reserve of instructions for proceeding in a second different instruction path (the branch not taken path). Accordingly, regardless of the branch outcome, instructions for both the first and second path may always be available to processor 1 for executing either path of the branch with zero penalty or delay. Program buffer 10 may store enough reserve instructions for the second path, where if the first instruction path is incorrect, processor 1 may run the program with the reserve instructions until the program control unit 8 may retrieve instructions for the second path from program memory 3.

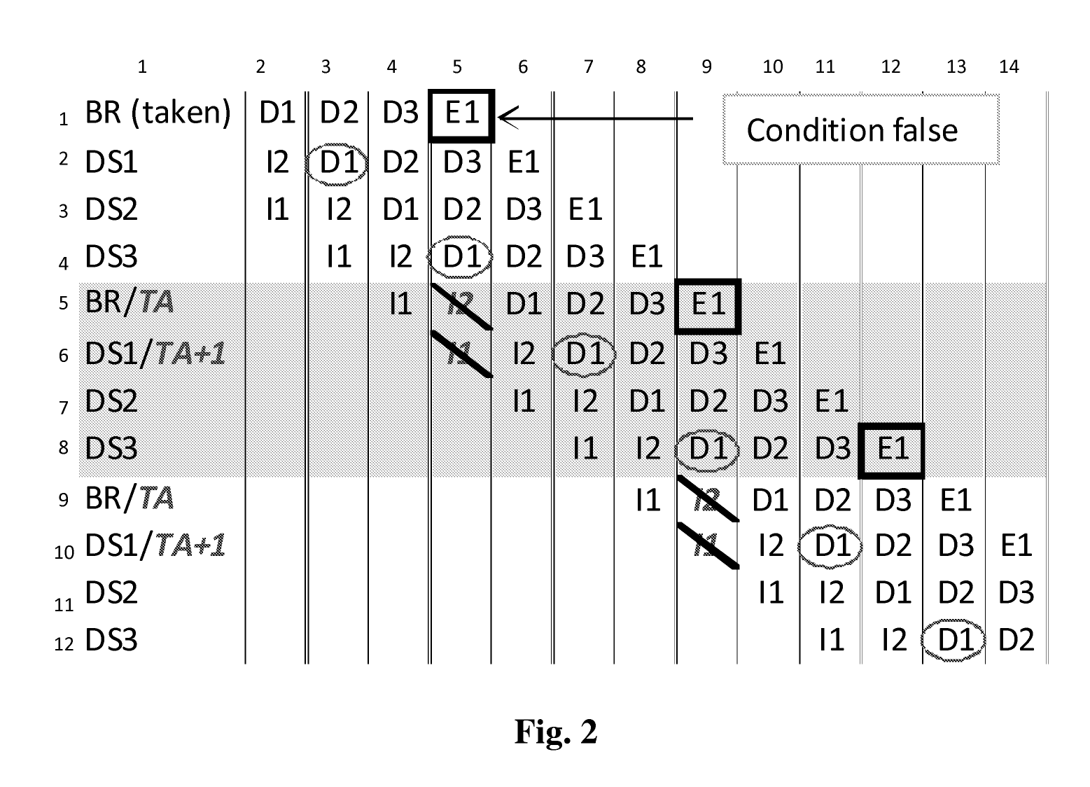

Reference is made to FIG. 2, which is a table showing processor operations initiated by a branch instruction in accordance with an embodiment of the invention. In FIG. 2, each row in the table shows the processor pipeline stages for a single instruction. The instructions (listed in column 1) are ordered in sequential rows in the order in which they are processed, i.e., in the order in which the instructions first enter the processor pipeline (in operation IF1). Each sequential column shows the operations executed on the instructions that occur in each sequential computational cycle. That is, once an instructions in each row first enter the processor pipeline, in each sequential column, the processor executes sequential operations on the instruction, e.g., program memory address (IF1), fetch (IF2), dispatch (D1), decode (D2), register file read (D3), and execute (E1). Other or additional operations may be used.

Each program fetch operation (IF1-IF2) may retrieve a burst or row of sequential instructions from a source program memory that fills an entire buffer unit. Each buffer unit may be wide enough to store more than one sequential instruction packet in each fetch cycle. However, only a single instruction packet may be retrieved from each buffer in each fetch cycle. By filling the buffers with sequential instructions at a faster rate than the buffered instructions are used, embodiments of the invention may accumulate a reserve of sequential instructions for executing the branch not taken path.

In the example of FIG. 2, a branch instruction (BR) is received (row 1). Branch instructions may indicate that a process should proceed next to either a first instruction (e.g., at a target address (TA) in a branch taken path) or a second instruction (e.g., at a sequential address in a branch not taken path), but the correct path is not known for several cycles (e.g., three cycles to process D2-E1 in row 1 from column 3 to 5). In that time, the branch path may be initially taken and may later be switched to not taken (using the reserve instructions) if the branch taken path proves incorrect. Delay slots (DS1-DS3 in rows 2-4) may be used to process the branch taken instruction in that time gap (columns 3 to 5), each retrieving a burst of instructions in the branch taken path. After the delay, the branch condition is determined to be false and the branch taken path is incorrect (row 1, column 5). The program may have wasted a number of (e.g., 5) cycles to retrieve instructions for the incorrect branch taken path and these instructions may be discarded (rows 5 and 6, column 5). To recover without stalling the program, the program may be supplied with a reserve of instructions for the correct branch not taken path sufficient to sustain the program for the same number of recovery cycles. For example, when the program runs at a rate of 1 instruction packet per cycle, 5 reserve instruction packets may be sufficient to run the program for 5 recovery cycles. Once the correct path is determined, the discarded (branch taken) instructions may be instantaneously swapped with the reserve (branch not taken) instructions (rows 5 and 6, column 5). While the reserve instructions are being used to recover from the mis-prediction, the processor may return to the program memory, this time to retrieve the correct branch not taken instructions sequentially following those in the reserve (rows 7, column 6 and row 8, column 7). The processor may retrieve the branch not taken instructions at a rate faster than they are used, for example, to once again accumulate a reserve of sequential branch not taken instructions.

In the example of FIG. 2, another branch instruction is received (row 5) and the process is repeated. That is, the branch taken path is initially used (row 5, column 4) and then determined to be incorrect (row 5, column 9). The instructions retrieved for the branch taken path may be discarded (rows 9 and 10, column 5) and replaced with reserve instructions for the branch not taken path. While the reserve instructions are being used, the processor may return to the program memory and refill the buffers with branch not taken instructions.

In the example of FIG. 2, a third branch instruction is received (row 9) and the process is again repeated.

The example of FIG. 2 shows a worse-case scenario in which a program includes a sequence of branch instructions (rows 1, 5 and 9), which repeatedly cause the program to take the incorrect path. The branch instructions may be the highest-density of branch instructions allowable in some programs (branch instructions are typically separated by delay slots) and thus the most difficult scenario from which the program may recover. In such a worse-case scenario the program recovers with zero penalty or time delay and thus may recover with zero penalty or time delay in any other scenario.

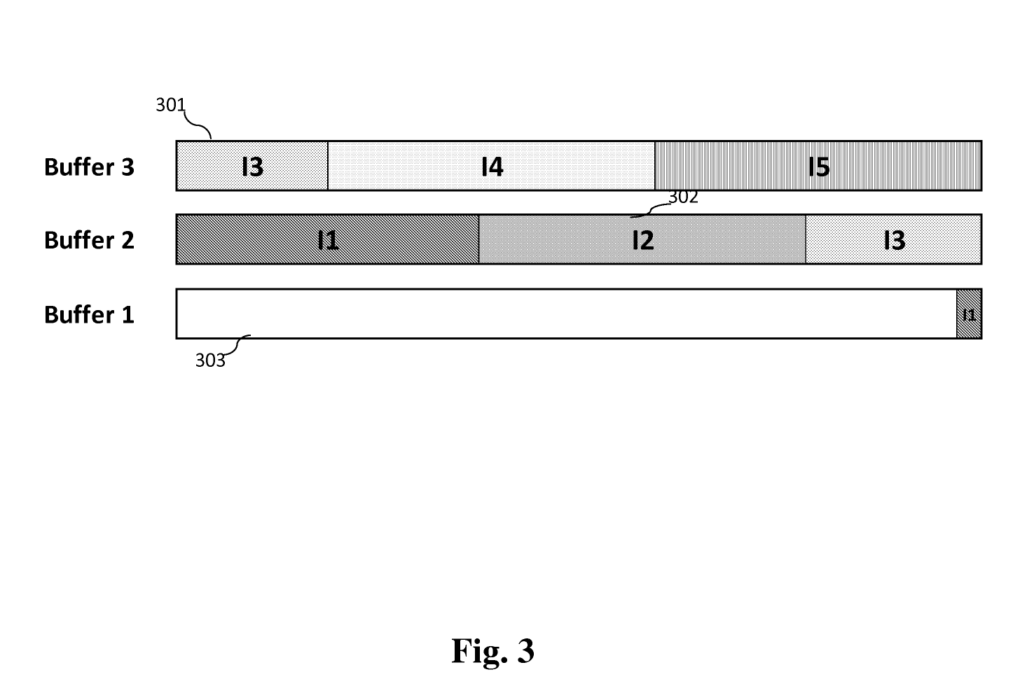

Reference is made to FIG. 3, which schematically illustrates a plurality of buffers 301-303 for storing instructions in accordance with an embodiment of the invention. Each buffer 301-303 may be an individually addressable unit in a program buffer (e.g., program buffer 10 of FIG. 1).

Buffers 301-303 may be filled with sequential instructions from a source program memory so that, when a branch instruction is encountered, buffers 301-303 have a sufficient reserve of instructions to recover from a mis-prediction with zero penalty or time delay. Each buffer 301-303 may be filled in each fetch cycle with a maximum number of instructions that fit the buffer 301-303. Buffers 301-303 may be filled with different numbers of instructions and portions or non-integer numbers of instructions. Each buffer 301-303 may be wide enough to store more than one sequential instruction packet for each single instruction packet of maximal allowed size retrieved from the buffers in a fetch cycle. By inputting more instructions into each buffer than are output therefrom, buffers 301-303 may accumulate a reserve of sequential instructions for the branch not taken path.

The reserve may be large enough to fully occupy the program while recovering from any mis-predictions. In one example, the reserve may include at least (N+M) branch not taken instruction packets to replace the branch taken instruction packets retrieved in the number of (N) cycles while the program was determining the branch condition (D2-E1) and an additional (M) cycles used to fetch the branch not taken instruction packets from the program memory (IF1-IF2). In one embodiment, a total of five reserve instruction packets are used to recover from each branch mis-prediction. The example of FIG. 3 shows a worst-case scenario, in which buffer 303 is nearly empty, but still contains a segment of an instruction packet and thus, may not be refilled with new instructions. Even in this worst-case scenario, buffers 301-303 contain a sufficient reserve of instructions (e.g., five) used to recover from a mis-prediction.

The reserve instructions for each recovery may be contained in a single buffer or alternatively, may be divided among a plurality of buffers. The larger the buffers, the fewer cycles needed to replenish the reserve of instructions, but the more physical space wasted on a processing chip. In one example, three buffers are used, sized to accumulate the five reserve instruction packets in two cycles.

Other buffer sizes, numbers of reserve instruction and numbers of recovery cycles may be used.

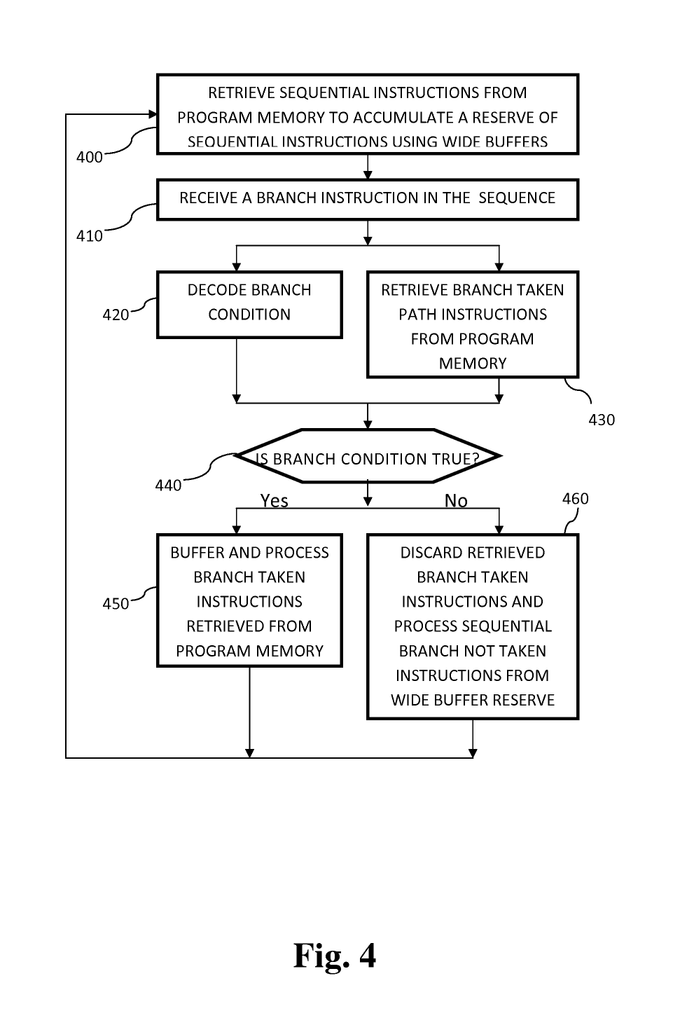

Reference is made to FIG. 4, which is a flowchart of a method in accordance with an embodiment of the invention.

In operation 400, a processor (e.g., processor 1 of FIG. 1) may retrieve sequential instructions from a program memory (e.g., program memory 3 of FIG. 1) to be stored in a single individually addressed buffer (e.g., in program buffer 10 of FIG. 1). The sequential instructions may be retrieved in bursts or batches, for example, to completely fill the buffer. The buffers may be wide enough to fit more than one sequential instruction packet.

In operation 410, the processor may detect a branch instruction in the retrieved instructions. The outcome of the branch instruction may depend on a branch condition that is not yet known.

In operation 420, the processor may decode the branch condition (D2-E1) to determine the branch condition and thus, the correct instruction path.

In operation 430, while the decoding the branch condition and before the correct branch path is known, the processor may proceed in the branch taken path to retrieve non-sequential instructions from the program memory.

In operation 440, the processor may determine if the outcome of the branch condition and thus, the correct instruction path. If the branch condition is true and the branch taken path is correct, a process or processor may proceed to operation 450. Otherwise, if the branch condition is false and the branch taken path is incorrect, a process or processor may proceed to operation 460.

In operation 450, the processor may fill the addressed buffer with the non-sequential branch taken instructions retrieved in operation 430 and proceed to process those instructions.

In operation 460, the processor may discard the branch taken instructions retrieved in operation 430 and proceed to process sequential instructions from the reserve accumulated in operation 400.

After either processing the non-sequential in operation 450 or the sequential instructions in operation 450, a process or processor may proceed to operation 400, to continue retrieving instructions sequential to the last processed (branch taken or branch not taken) instructions.

Other operations or orders of operations may be used.

In one embodiment, a process or processor may switch back and forth between branch mechanisms operating according to embodiments of the invention and conventional branch prediction mechanisms. Each mechanism may have its own advantages and disadvantages. For example, embodiments of the invention may provide zero penalty branch recovery to reduce branch mis-prediction delays compared with conventional systems, but may also use wider buffers using more physical space on processing chips than conventional mechanisms. In some cases, the benefits of embodiments of the invention may be more prominent when branch conditions are difficult to predict and mis-predictions are frequent to significantly reduce processing delays, while the benefits of conventional mechanisms may be more prominent when branch conditions are easy to predict and mis-predictions occur only occasionally. To extract the benefits of both designs, some embodiments may selectively activate branch mechanisms operating according to embodiments of the invention when branch conditions are difficult to predict and conventional mechanisms when branch conditions are easy to predict. The difficulty or ease at which branch conditions are predicted may be determined by a history or log of mis-predictions, program speed, or a setting entered by a user or programmed.

As it is used herein, a processing “path” may refer to any sequence of instructions, operations or steps, which may be implemented by either hardware or software modules.

An instruction packet may contain a single instruction or more than one instruction. One instruction packet (or a predefined number of packets) may be processed, transferred, sent, received, stored and used in each instruction cycle. In some examples herein, an instruction packet may refer to a worst-case scenario packet of maximal allowed size (e.g., a very long instruction word (VLIW)).

It should be appreciated by a person skilled in the art that although instructions are described to be fetched to a buffer memory, any other type of memory may be used to store the instructions including volatile memory, non-volatile memory, dynamic or static memory, cache memory, registers, tables, etc. Furthermore, any data other than instructions may also be retrieved according to embodiments of the invention.

It should be appreciated by a person skilled in the art that the instructions referred to in embodiments of the invention may be executed to manipulate data representing any physical or virtual structure, such as, for example, video, image, audio or text data, statistical data, data used for running a program including static and/or dynamic data, etc.

Embodiments of the invention may include an article such as a computer or processor readable non-transitory medium, or a computer or processor storage medium, such as for example a memory, a disk drive, or a USB flash memory, encoding, including or storing instructions which when executed by a processor or controller (for example, processor 1 of FIG. 1), carry out methods disclosed herein.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

What is claimed is:

1. A method for executing a branch instruction in a program, the method comprising:
receiving the branch instruction defining a plurality of different possible instruction paths;
automatically retrieving instructions for an initial predefined one of the paths from a program memory while the correct path is being determined;
if the initial path is determined to be correct, continuing to process the instructions retrieved for the initial path and
if a different path is determined to be correct, processing instructions from a stored reserve of instructions for the different path to supply the program with enough correct path instructions to run the program at least until the program retrieves the correct path instructions from the program memory to recover from taking the incorrect path.

2. The method of claim 1 comprising storing a reserve of instructions for each path not automatically taken to continue running the program while recovering if an incorrect path is taken.

3. The method of claim 1, wherein a number of reserve instructions for each path is greater than or equal to a number of instructions processed by the program during (N) cycles used to determine the correct path and an additional (M) cycles used to retrieve the other path instructions from the program memory.

4. The method of claim 1 comprising refilling the stored reserve each time the incorrect path is taken and the stored reserve is depleted to run the program during recovery.

5. The method of claim 4, wherein the stored reserve is refilled by adding instructions to the reserve at a faster rate than the rate at which instructions are retrieved from the reserve.

6. The method of claim 5, wherein instructions are added to fill a buffer in each cycle, where the buffer is sized to store more than one instruction packet of maximal allowable size for every one instruction packet of maximal allowable size retrieved per cycle.

7. The method of claim 1, wherein the initial predefined path is a branch taken path and the other path is a branch not taken path.

8. The method of claim 1, wherein there are a total of 2^{N} different possible instruction paths and the stored reserve includes instructions for each of the 2^{N}−1 branch paths not automatically taken.

9. The method of claim 1, wherein the program incurs zero computational penalty to recover from taking the incorrect path.

10. The method of claim 1 comprising selectively activating a branch predictor to predict the correct instruction path when branch conditions are easy to predict and selectively activating the automatic instruction retrieval when branch conditions are difficult to predict.

11. A system comprising:
a program memory to store instructions for a program;
an intermediate memory to store instructions retrieved from the program memory to prepare the instructions for execution by the program; and
a processor to receive a branch instruction defining a plurality of different possible instruction paths and to automatically retrieve instructions for an initial predefined one of the paths from the program memory while the correct path is being determined, wherein if the initial path is determined to be correct, the processor continues to process the instructions retrieved for the initial path and if a different path is determined to be correct, the processor processes instructions from a stored reserve of instructions in the intermediate memory for the different path to supply the program with enough correct path instructions to run the program at least until the program retrieves the correct path instructions from the program memory to recover from taking the incorrect path.

12. The system of claim 11, wherein the intermediate memory stores a reserve of instructions for each path not automatically taken for the processor to continue running the program while recovering if an incorrect path is taken.

13. The system of claim 11, wherein the intermediate memory includes a number of reserve instructions for each path that is greater than or equal to a number of instructions processed by the program during (N) cycles used to determine the correct path and an additional (M) cycles used to retrieve the other path instructions from the program memory.

14. The system of claim 11, wherein the intermediate memory is a buffer memory.

15. The system of claim 11, wherein the processor refills the stored reserve in the intermediate memory each time the processor takes an incorrect path and depletes the stored reserve to run the program during recovery.

16. The system of claim 15, wherein the processor refills the stored reserve by adding instructions to the reserve at a faster rate than the rate at which instructions are retrieved from the reserve.

17. The system of claim 16, wherein the processor refills the stored reserve by adding instructions to fill an entire unit of the intermediate memory in each cycle, where the intermediate memory unit is sized to store more than one instruction packet of maximal allowable size for every one instruction packet of maximal allowable size retrieved per cycle.

18. The system of claim 11, wherein the initial predefined path is a branch taken path and the other path is a branch not taken path.

19. The system of claim 11, wherein there are a total of 2^{N} different possible instruction paths and the stored reserve includes instructions for each of the 2^{N}−1 branch paths not automatically taken.

20. The system of claim 11, wherein the processor incurs zero computational penalty to recover from taking the incorrect path.
